(19) United States
(12) Patent Application Publication
(10) Pub. No.: US 2012/0166405 A1
(43) Pub. Date: Jun. 28, 2012

(54) Changeability And Transport Release Check Framework

(76) Inventors: Christoph Barbian, Heidelberg (DE); Michael Wagener, Wiesloch (DE)

(21) Appl. No.: 12/980,129

(22) Filed: Dec. 28, 2010

(51) Int. Cl. G06F 17/30

(52) U.S. Cl. 707/694; 707/E17.005

(57) ABSTRACT

Disclosed are methods, systems and products, including a method that includes receiving an object including an identifier to determine whether the object is subject to at least one of a change during a transaction and a transport from a first system to a second system; determining attributes for the received object; determining a rule based on at least the identifier and the determined attributes; and allowing an action comprising at least one of the change to the object and the transport of the object based on a result of a rule check performed using the determined rule. Related systems, methods, and articles of manufacture are also disclosed.

### TECHNICAL FIELD

The present disclosure relates to data processing.

### BACKGROUND

In complex business applications, data being accessed by a user at a client may be locked to prevent changes while the data is being accessed by another. For example, when a ticket agent makes a seat reservation and/or purchase, the underlying business application may make a changeability check to determine whether the data may be changed during the transaction. In this example, the data is unlikely to be changeable as the ticket agent would not want changes to the data object corresponding to the seat reservation/purchase transaction during the transaction (which could otherwise result in someone else reserving/purchase the seat in the middle of the transaction).

Complex business applications may also include transport mechanisms to distribute data, such as software updates, forms, and the like. These transport mechanisms may also include checks to make sure that the transported data is handled properly from a source system providing the data to a target system receiving the data.

### SUMMARY

In one aspect, a method is disclosed. The method includes receiving an object including an identifier to determine whether the object is subject to at least one of a change during a transaction and a transport from a first system to a second system; determining attributes for the received object; determining a rule based on at least the identifier and the determined attributes; and allowing an action comprising at least one of the change to the object and the transport of the object based on a result of a rule check performed using the determined rule.

Embodiments of the method also include one or more of the features described herein including one or more of the following features. The object may include at least one of data, software, a software patch, a configuration file, an updated program, an updated operating system, a report, a class, a function, a table, and a table entry. The object may be received in a transport request. The attributes may be determined for the received object by accessing at least one catalog including the attributes. The attributes may include at least one of an object catalog key, a package development class, a source system for the object, a transport layer development class, a software component identifier, a namespace, a current client number, and a current user name. The action may be allowed by further performing at least one of a transport check and a changeability check on the object. The rule may be determined by identifying the rule from a hierarchy of rules. The rule check may also include selecting the rule from the hierarchy of rules. Related systems and articles of manufacture are also disclosed.

Details of one or more implementations are set forth in the accompanying drawings and in the description below. Further features, aspects, and advantages will become apparent from the description, the drawings, and the claims.

### BRIEF DESCRIPTION OF THE DRAWINGS

FIG. 1 is a schematic diagram of an example system including a rules check module;

FIG. 2 depicts an example of a changeability check stack and a transportability check stack, each of which includes a rules check;

FIG. 3 depicts an example of rules for use by the rules check module; and

FIG. 4 is a flowchart for processing at least one rule in connection with a changeability check and/or a transportability check.

Like reference numbers and designations in the various drawings indicate like elements.

### DETAILED DESCRIPTION

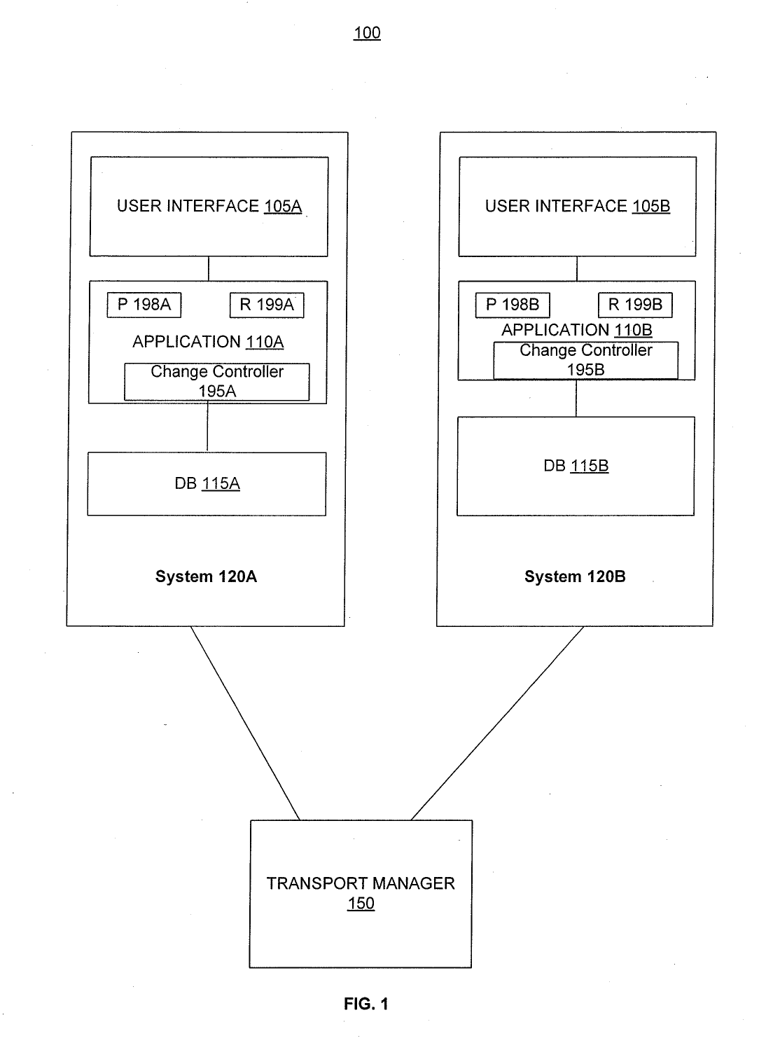

FIG. 1 depicts a system landscape 100 including one or more systems, such as systems 120A-B coupled to a transport manager 150.

The system 120A further includes a user interface 105A, one or more applications 110A, a change controller 195A, a rules module 199A (also referred to herein as a rules checker and a rules checker module, labeled “R”), a transport manager proxy 198A (labeled “P”), and a database 115A, all of which are coupled by a communication mechanism, such as an intranet or the Internet.

User interface 105A may be implemented as any type of interface mechanism for a user, such as a web browser, a client, a smart client, and any other interface mechanism. Database 115A (labeled “DB”) may be implemented as any type of database.

The one or more applications 110A may be implemented as any type of program. In some implementations, the applications 110A may be implemented as a business application, such as an enterprise resource planning application, and may be implemented using ABAP, although mechanisms may be used to implement applications 110A. The change controller 195A provides a mechanism for locking data in the database 115A during a transaction. The rules module 199A enforces rules, as described further below, and the transport manager proxy 198A is a proxy for the transport manager 150.

System 120B further includes a user interface 105B, one or more applications 110B, a change controller 195B, a rules module 199B (labeled “R”), a transport manager proxy 198B (labeled “P”), and a database 115B, all of which are coupled by a communication mechanism, such as an intranet or the Internet. User interface 105B, applications 110B, change controller 195B, rules module 199B, transport manager proxy 198B, and database 115B may be implemented as described above with respect to system 120A. The system 120B is further coupled, via a communication mechanism, to transport manager 150, and has access to an interface at, for example, transport manager 150.

The transport manager 150 may organize, perform, and/or monitor transport between systems 120A-B. In some implementations, the transport manager 150 may include proxies 198A-B at the systems 120A-B. Moreover, the transport manager 150 may be implemented as part of SAP's transport management system, such as an ABAP transport and change system configured to operate using the subject matter described herein, although the subject matter described herein is operative with non-SAP systems as well.

Transport manager 150 may be implemented as one or more data processors, such as a server, a computer, a blade, and the like, and may include a so-called “transport layer” of software to manage and route transport requests including packages, which further include objects, as described below. For example, the transport manager 150 may be used to organize, perform, and monitor transport requests between systems 120A-B. Specifically, transport manager 150 may perform one or more of the following: configure the transport routes (e.g., paths) between systems 120A-B; display the import queues (e.g., transport requests including objects waiting to be routed and disseminated to a target system or application); import requests in an import queue; import all the requests in a project (e.g., a plurality of transport requests associated with a software update); import a specific transport request; provide quality assurance; and provide workflow (e.g., route and deploy from a source application to a target application). The transport manager 150 may also include persistency, such as memory or storage, for the transport requests, objects, and the like.

The transport request may be used to transport packages including one or more objects. The term object refers to data including, for example, one or more of the following: software, data, a software patch, a configuration file, an updated (e.g., new, revised, and the like) program, an updated operating system, a report, a class, a function, a table, a table entry, a business configuration setting, and the like.

In some implementations, an object may be uniquely identified by a triple of the following form: PGMID (program id), OBJTYPE (object type), OBJ_NAME (object name), wherein PGMID represents a program identifier, OBJTYPE represents an object type (e.g., a character strings having a length of 4), and OBJ_Name represents the name of the object (e.g., a character strings having a length of 120).

The objects may be included, or recorded, in a transport request under the control of transport manager 150. When this is the case, the object is called a transportable object. One or more of the transportable objects may also be lockable objects. Lockable objects are objects stored in a repository, such as databases 115A-B. In some implementations, the lockable objects may also include objects which are not user content (e.g., all ABAP sources, the database table definitions and the like). The lockable object may be uniquely identified by a triple of the form: PGMID (program id), OBJTYPE (object type), OBJ_NAME (object name), wherein PGMID represents a program identifier, object type represents a character string identifying the object type (e.g., a character string of length four), and the OBJ_NAME represents the object name (e.g., a character string of 40 characters).

The lockable objects may also be listed (or registered) in an object catalog table (e.g., in an object directory, such as a TADIR), which lists all objects in database 115A and upon which the application 110A is based. In some implementations, a lockable object may be assigned to exactly one package (or development class). As used herein, a package refers to a unit including one or more objects. For example, a package may correspond to the smallest unit packaging a group of objects, which are associated from a semantic perspective.

Packages and their attributes are listed in a package catalog table (e.g., a TDEVC listing available development classes and packages). Packages may have attributes such as a software component, a namespace, and a transport layer. A software component is the smallest unit of software that can be shipped to a customer. Namespaces are prefixes used to group objects across packages according to their affiliation to an application. The namespace and software component of an object may thus be determined by the package to which the object is assigned. The transport layer provided by the transport manager 150 is used to determine how and where objects are transported.

When there is a change, or a creation of an object, that can be locked (“lockable object”), the change controller 195A and/or the transport manager 150 (or a corresponding proxy 198A at application 110A) may perform one or more of the following checks: check whether the application 110A can be modified in the transport manager; check whether the repository, such as databases 115A-B, is changeable in a current client; check whether the namespace of an object is modifiable in the transport manager 150; and check whether the software component of the object is modifiable in the transport manager 150.

If at least one or more of the aforementioned checks fail, then the change controller 195A (and/or the transport manager 150 or the corresponding proxy 198A) may prevent a user at a user interface from changing the object. Similarly, if a user at a user interface tries to release a transport request for transport via transport manager 150, every lockable object included, or recorded, in the transport request may also be checked to determine whether the transport layer of the object/package matches the transport target of the transport request. For example, if a developer creates a transport request, the transport request includes a defined transport target. When objects are inserted into the transport request (e.g., because a developer has changed the objects), the system verifies that the transport layer assigned to each inserted object corresponds to a correct destination, such as the correct target system/application.

In some implementations, the subject matter described herein may perform a rules check using a rules module, such as rules modules 199A-B. The rules check may be called by any module of system 120A-B. For example, a client applet (such as for example an editor of an ABAP workbench) at user interface 115 may call at least one of rules module 199A-B to perform a rules check with respect to the changeability and/or transportability of an object being handled by the client applet.

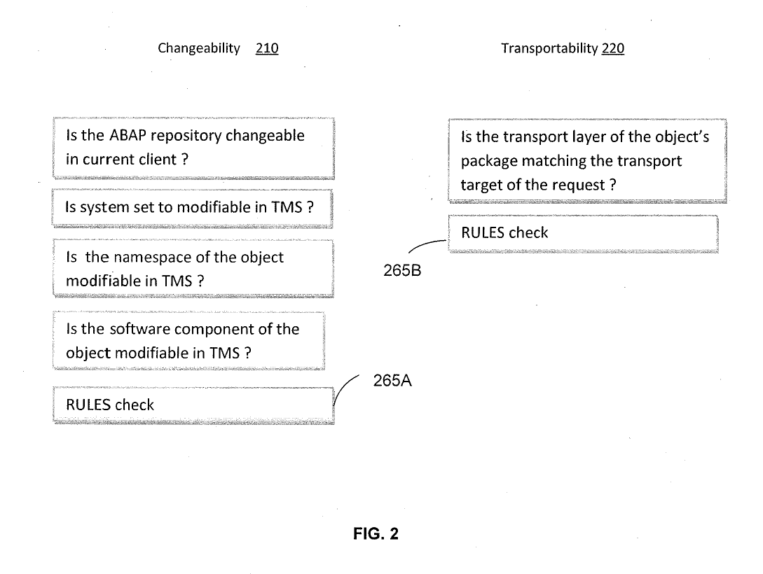

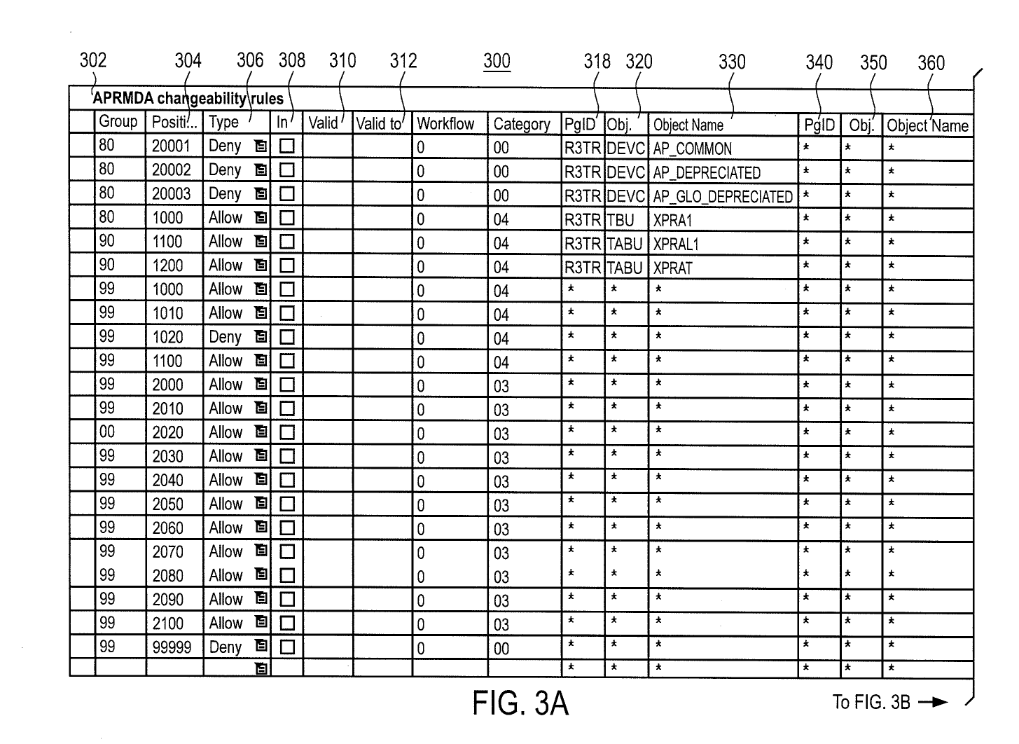

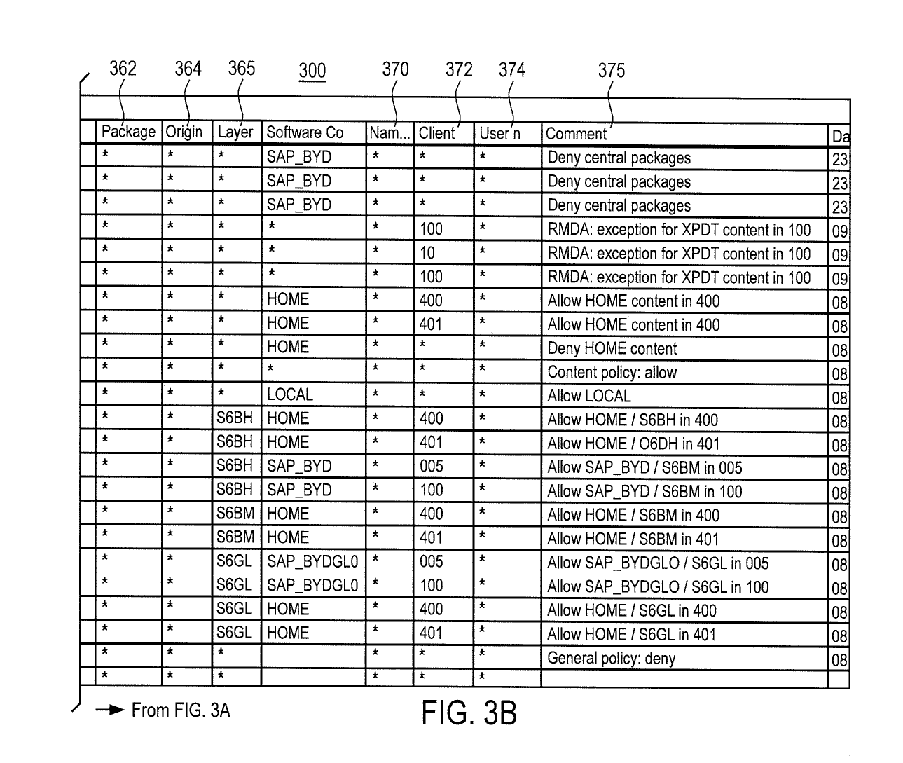

FIG. 2 depicts changeability checks 210 and transportability checks 220. The changeability checks 210 may be performed by the application 110A (and/or the change controller 195A) to check whether a repository, such as database 115A, is changeable in a given client (e.g., user interface 105A); check whether the application 110A can be modified in the transport manager 150, check whether the namespace of an object is modifiable in the transport manager 150; check whether the software component of the object is modifiable in the transport manager 150, and the like. The changeability checks 210 may also include the rules check 265A, which checks rules, as described further below with respect to FIG. 3.

The transportability checks 220 may be performed by the application 110A (or the transport manager 150 or its proxy 198A). The transportability checks include determining whether the transport request sent by system 120A matches a transport target, such as system 120B. The transportability checks 220 may also include a rules check 265B, which checks rules, as described further below with respect to FIG. 3.

FIG. 3 depicts an example of rules used by rules check modules 199A-B. The group and position identifiers 302 and 304 identify the rule uniquely from other rules. The type 306 defines whether the rule denies or allows a package. The invalid rule column 308 invalidates a rule when selected. The valid from 310 and valid to fields 312 provides a data range describing when a rule can be processed. The fields PgID 318, Obj 320, and object name 330 are part of the object itself. The package field 362 defines the package, and the original field 364 defines the source of the package originated. A namespace 370 may be defined as well.

For example, whenever a changeability check and/or a transport check are performed on an object, one or more of the following operations are performed by the rules check module. The input to the rules check module is an identifier of the object (e.g., a triple of the form TR_PGMID, TR_OBJECT, TR_OBJ_NAME). Next, the rules check module determines attributes for the object.

For example, one or more of the following attributes may be determined for the object: an object catalog key (e.g., PGMID, OBJECT, and/or OBJ_NAME), a package development class (which may be obtained from the object catalog for the object); a source system for the object (which may be obtained from the object catalog); a transport layer development class (which may be obtained from a package catalog); a software component identifier (which may be obtained from the package catalog); a namespace 370 (which may be obtained from the package catalog); a current client number 372; and a current user name 374. Although FIG. 3 depicts the rules in tabular form, the rules may be organized in other ways as well. Moreover, the rules in FIG. 3 are only exemplary as other rules may be used as well.

The rules check module, such as rules check modules 199A-B, may then determine whether to allow or deny an action to an object based on the first rule at FIG. 3 that matches the input identifier and the determined attributes. For example, suppose that some user tries to change a function module named MY_EXAMPLE_FUNCTION, and that function module was originally created in a package named MY_EXAMPLE_HOME_PACKAGE, which has been assigned to a software component called HOME and which has transport layer S6TF (see FIG. 3 at 365). Moreover, suppose the user is attempting this change in client 100, in which case the check would be called with an identifier having the following triple as an input: TR_PGMID=LIMU, TR_OBJECT=FUNC (which corresponds to an object identifier for functions), and TR_OBJ_NAME=MY_EXAMPLE_FUNCTION. Given the previous example, the determined attributes are listed at Table 1. The LIMU represents a technical identifier portion of the object.

TABLE 1
PGMID = R3TR (also a technical PGMID identifier)
OBJECT = FUGR (the object identifier for function groups: a function
group is a collection of single functions)
OBJ_NAME = MY_EXAMPLE_FUNCTION_GROUP
DEVCLASS = MY_EXAMPLE_HOME_PACKAGE
DLVUNIT = HOME
PDEVCLASS = S6TF
CLIENT = 100
USERNAME = MY_USER

In the above example, the only matching rule is rule 99:99999 at the last line of FIG. 3, which is a general deny rule. In this example, the action would be denied, i.e., not allowed. The outcome is indeed correct because the user MY USER is working in the wrong client 100 (since 100 is the designated for shipped development). If the developer instead logs into client 400 (which is the designated client for HOME development for an internal, non-shipped development in this example), then the rule 99:2010 would be the matching rule, which corresponds to an allow rule. Thus, the action is allowed to proceed. The previous example is merely an example as other rule scenarios may be implemented as well in conjunction with the change and transportability checks.

In some implementations, the rules may be configured in a table (or hierarchy), so that the first rule having a matching input identifier and attributes is executed/processed and any remaining rules are not executed/processed. In the example of FIG. 3, the last rule is configured as a default that denies any actions if the prior rules (which include allowed actions to objects) do not match. Specifically, in FIG. 3, if none of the rules corresponding to rules 99:2000-99:2100 are executed/processed (e.g., the input triplet and the attributes do not match a corresponding rule), and then rule 99:9999 is executed/processed, which corresponds to deny any action to an object.

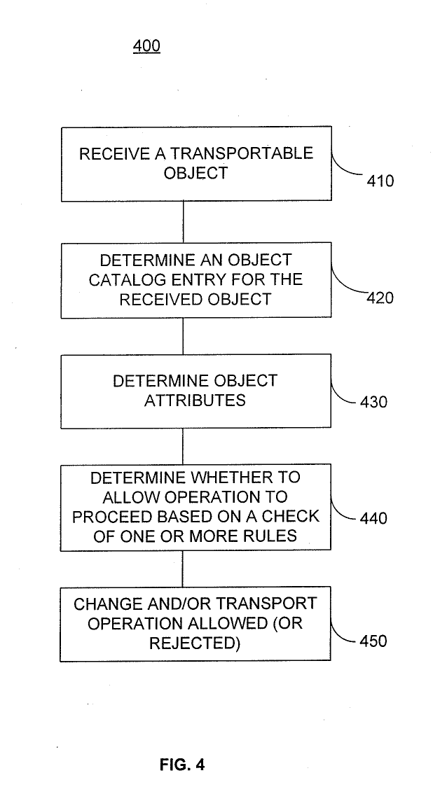

FIG. 4 depicts a process 400 for using the rules check module.

At 410 an object, such as a transportable object is received at the rules check module. The object is typically received for transport to one or more systems via the transport manager 150. For example, when a software update occurs to an object, the object is included in a transport request for dissemination to one or more systems.

At 420, the rules check module may determine an object catalog entry corresponding to the transportable object received at 420. If the received object is lockable (or part of a lockable object), then this may occur canonically. In all other cases (e.g. if the input object is content), a special process applies.

At 430, the rules check module determines object attributes from the object catalog, and determines package attributes from a package catalog (e.g., via a package assignment).

At 440, the rule check module may determine, based on one or more rules of the rules check, whether the operation is allowed or not (e.g., taking into account the current user and current client). At 450, the change and/or transport operation for the received object is allowed to proceed or rejected based on at least the rules.

In some implementations, the rules check module may thus use the rules to enhance the granularity of transport and change checks, providing enhanced control of objects and transport request. For example, the changeability of a software component or a namespace may be restricted to a specific client using a rule. In this example, a given software component at a given client, such as HOME which is reserved for internal development in this example, can be restricted so that the software component can only be changed/transported in specific clients according to a rule. In the example of FIG. 3, clients 400, 401 are allowed to perform actions to software components associated with HOME; clients 005 and 100 are allowed to perform actions to software components associated with a cloud-based software-as-a-service business system. Moreover, the rules may be used to restrict changes to a package which has a transport layer that is non-local to a system.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description makes references to specific products, other products may be used as well. The term set includes zero or more elements. In addition, the logic flows depicted in the accompanying figures and described herein do not require the particular order shown, or sequential order, to achieve desirable results. Other embodiments may be within the scope of the following claims.

What is claimed is:

1. A computer-implemented method comprising:
receiving an object including an identifier to determine whether the object is subject to at least one of a change during a transaction and a transport from a first system to a second system;
determining attributes for the received object;
determining a rule based on at least the identifier and the determined attributes; and
allowing an action comprising at least one of the change to the object and the transport of the object based on a result of a rule check performed using the determined rule.

2. The computer-implemented method of claim 1, wherein the object comprises at least one of data, software, a software patch, a configuration file, an updated program, an updated operating system, a report, a class, a function, a table, and a table entry, and wherein the receiving, the determining attributes, the determining the rule, and the allowing are implemented on at least one processor.

3. The computer-implemented method of claim 1, wherein the object is received in a transport request.

4. The computer-implemented method of claim 1 further comprising:
determining the attributes for the received object by accessing at least one catalog including the attributes.

5. The computer-implemented method of claim 4, wherein the attributes comprise at least one of an object catalog key, a package development class, a source system for the object, a transport layer development class, a software component identifier, a namespace, a current client number, and a current user name.

6. The computer-implemented method of claim 1, wherein allowing the action further comprises performing at least one of a transport check and a changeability check on the object.

7. The computer-implemented method of claim 1, wherein determining the rule further comprises identifying the rule from a hierarchy of rules, and wherein the rule check includes selecting the rule from the hierarchy of rules.

8. A machine-readable storage medium including code which when executed by a machine provides operations comprising:
receiving an object including an identifier to determine whether the object is subject to at least one of a change during a transaction and a transport from a first system to a second system;
determining attributes for the received object;
determining a rule based on at least the identifier and the determined attributes; and
allowing an action comprising at least one of the change to the object and the transport of the object based on a result of a rule check performed using the determined rule.

9. The machine-readable storage medium of claim 8, wherein the object comprises at least one of data, software, a software patch, a configuration file, an updated program, an updated operating system, a report, a class, a function, a table, and a table entry.

10. The machine-readable storage medium of claim 8, wherein the object is received in a transport request.

11. The machine-readable storage medium of claim 8 further comprising:
determining the attributes for the received object by accessing at least one catalog including the attributes.

12. The machine-readable storage medium of claim 11, wherein the attributes comprise at least one of an object catalog key, a package development class, a source system for the object, a transport layer development class, a software component identifier, a namespace, a current client number, and a current user name.

13. The machine-readable storage medium of claim 8, wherein allowing the action further comprises performing at least one of a transport check and a changeability check on the object.

14. The machine-readable storage medium of claim 8, wherein determining the rule further comprises identifying the rule from a hierarchy of rules, and wherein the rule check includes selecting the rule from the hierarchy of rules.

15. A system comprising:
at least one processor; and
at least one memory including code which when executed provides operations comprising:
receiving an object including an identifier to determine whether the object is subject to at least one of a change during a transaction and a transport from a first system to a second system;
determining attributes for the received object;
determining a rule based on at least the identifier and the determined attributes; and
allowing an action comprising at least one of the change to the object and the transport of the object based on a result of a rule check performed using the determined rule.

16. The system of claim 15, wherein the object comprises at least one of data, software, a software patch, a configuration file, an updated program, an updated operating system, a report, a class, a function, a table, and a table entry.

17. The system of claim 15, wherein the object is received in a transport request.

18. The system of claim 15 further comprising:
determining the attributes for the received object by accessing at least one catalog including the attributes.

19. The system of claim 18, wherein the attributes comprise at least one of an object catalog key, a package development class, a source system for the object, a transport layer development class, a software component identifier, a namespace, a current client number, and a current user name.

20. The system of claim 15, wherein allowing the action further comprises performing at least one of a transport check and a changeability check on the object.
